(19) United States
(12) Patent Application Publication
(10) Pub. No.: US 2023/0084962 A1
(43) Pub. Date: Mar. 16, 2023

(54) Aerosol Generation Device, Battery Unit

(71) Applicant: JT International SA, Geneva (CH)

(72) Inventor: Ernst Hupkes, Kampen (NL)

(73) Assignee: JT International SA, Geneva (CH)

(21) Appl. No.: 17/800,773

(22) PCT Filed: Feb. 23, 2021
(86) PCT No.: PCT/EP2021/054452

§ 371 Date: Aug. 18, 2022

(30) Foreign Application Priority Data
Feb. 28, 2020 (EP) 20160265.3

(51) Int. Cl. A24F 40/485; H01M 50/202; H01M 50/342; H01M 50/247; H01M 50/224; H01M 50/291; H01M 50/548; H01M 10/658

(52) U.S. Cl. CPC A24F 40/485; H01M 50/202; H01M 50/3425; H01M 50/247; H01M 50/224; H01M 50/342; H01M 50/291; H01M 50/548; H01M 10/658; H01M 2220/30

(57) ABSTRACT

A battery unit includes a housing having a vent hole; a pouch battery within the housing, an outer surface of the battery including a plurality of possible vent points where a fluid may be released during degassing of the battery; and a fluid directing arrangement within the housing, the fluid directing arrangement being configured to define a fluid flow path from each of the plurality of possible vent points of the battery to the vent hole of the housing. A breakable seal may be positioned across the vent hole of the housing, the seal being configured to be displaced or broken to open the vent hole during degassing of the battery. An aerosol generation device includes a heating chamber and the battery unit, wherein the housing further includes a mouth end and an opposing end, the vent hole disposed at the opposing end.

### TECHNICAL FIELD

The present disclosure relates to an aerosol generation device. The disclosure is particularly applicable to a portable aerosol generation device, which may be self-contained and low temperature. Such devices may heat, rather than burn, tobacco or other suitable aerosol substrate materials by conduction, convection, and/or radiation, to generate an aerosol for inhalation.

The present disclosure also relates to a battery unit suitable for an aerosol generation device.

### BACKGROUND

The popularity and use of reduced-risk or modified-risk devices (also known as vaporisers) has grown rapidly in the past few years as an aid to assist habitual smokers wishing to quit smoking traditional tobacco products such as cigarettes, cigars, cigarillos, and rolling tobacco. Various devices and systems are available that heat or warm aerosolisable substances as opposed to burning tobacco in conventional tobacco products.

A commonly available reduced-risk or modified-risk device is the heated substrate aerosol generation device or heat-not-burn device. Devices of this type generate an aerosol or vapour by heating an aerosol substrate that typically comprises moist leaf tobacco or other suitable aerosolisable material to a temperature typically in the range 150° C. to 350° C. Heating an aerosol substrate, but not combusting or burning it, releases an aerosol that comprises the components sought by the user but not the toxic and carcinogenic by-products of combustion and burning. Furthermore, the aerosol produced by heating the tobacco or other aerosolisable material does not typically comprise the burnt or bitter taste resulting from combustion and burning that can be unpleasant for the user and so the substrate does not therefore require the sugars and other additives that are typically added to such materials to make the smoke and/or vapour more palatable for the user.

There is a safety issue with certain aerosol generating devices powered by certain types of battery that can experience leaks or degassing events where a fluid (liquid or gas) is produced from the battery. For example, lithium ion batteries are known to experience degassing events. These events can be slow or small events that fall within normal behaviour of the battery, and do not necessarily compromise the functionality of the aerosol generation device. However, these events can also be rapid events that cause high pressures and damage the device or even cause the device to explode. This is particularly dangerous if the device is held in a user's hand or is close to the user's face. Additionally, the leaked or degassed fluid may be a hazardous chemical such as a flammable or toxic organic solvent.

In some batteries, there is a specific preferential vent point on an outer surface of the battery, at which fluid is preferentially released during a degassing event. However, this places restrictions on the internal structure of the battery. It is desirable to be able to instead use pouch batteries, which have multiple possible vent points on their surface and which can have a variety of internal structures (such as described in U.S. Pat. No. 7,629,077).

It is desirable to provide an aerosol generation device with improved safety and/or reliability, where power is supplied by a pouch battery.

For the same reasons it is also desirable to provide a battery unit for an aerosol generation device, where the battery unit comprises a pouch battery, with improved safety and/or reliability.

### SUMMARY

According to a first aspect, the present disclosure provides an aerosol generation device comprising: a heating chamber operable to heat an aerosol substrate to generate an aerosol; a housing comprising a mouth end and an opposing end, the opposing end comprising a vent hole; a pouch battery within the housing, an outer surface of the battery comprising a plurality of possible vent points where a fluid may be released during degassing of the battery; and a fluid directing arrangement within the housing, the fluid directing arrangement configured to define a fluid flow path from each of the plurality of possible vent points of the battery to the vent hole of the housing.

By providing a fluid directing arrangement configured to define a fluid flow path from each of the plurality of possible vent points of the battery to the vent hole of the housing, a pouch battery can be used with improved safety in an aerosol generation device.

Optionally, the aerosol generation device further comprises a seal positioned across the vent hole, the seal being configured to be displaced or broken to open the vent hole during degassing of the battery.

By providing the seal across the vent hole, contamination or damage of the aerosol generation device by, for example, ingress of water, is prevented during normal use, while still allowing fluid to escape from the device during a degassing event.

According to a second aspect, the present disclosure provides a battery unit for an aerosol generation device comprising: a housing comprising a vent hole; a pouch battery within the housing, an outer surface of the battery comprising a plurality of possible vent points where a fluid may be released during degassing of the battery; a fluid directing arrangement within the housing, the fluid directing arrangement being configured to define a fluid flow path from each of the plurality of possible vent points of the battery to the vent hole of the housing; and a seal positioned across the vent hole of the housing, the seal being configured to be displaced or broken to open the vent hole during degassing of the battery.

By providing a housing with a vent hole and a seal, a pouch battery can be more safely used in a battery unit.

In a possible arrangement of the first or second aspect, the fluid directing arrangement comprises a first heat shield wall which is positioned closer to a first end of the battery and the vent hole of the housing is positioned closer to a second end of the battery which is opposite to the first end. In other words, a distance between the first heat shield wall and the first end of the battery is smaller than a distance between the vent hole of the housing and the second end of the battery. Optionally, the fluid directing arrangement comprises a second heat shield wall which is positioned adjacent a side of the battery. Optionally, the fluid directing arrangement comprises an opening which is positioned adjacent a side of the battery for leaving the battery exposed; the opening extending along the second heat shield wall. Optionally, the second wall is distant from the housing such as to leave a cavity therebetween.

In the first or second aspect, the housing optionally comprises a first material and the seal is a housing portion comprising a second material, the second material being weaker than the first material such that the seal is displaced or broken to open the vent hole during degassing of the battery.

In particular, the second material may have a lower Young's modulus than the first material.

The housing optionally comprises a first material and the seal is a housing portion comprising a second material, the second material having a lower melting point than the first material.

In the first or second aspect, optionally the first material is a metal and the second material is a plastic.

By using a weaker material for the seal than for the housing, the seal is broken in preference to the housing and safety is improved.

Optionally, the seal takes the form of a plug comprising a plastic material, such as a plastic resin, or a cover comprising a plastic or foil, such as a PET-foil sticker.

In the first or second aspect, the seal optionally comprises a resilient element configured to engage with the housing to snap the seal into place during assembly, but configured to inhibit external removal of the seal from the housing. In a possible mode, the resilient elements are tabs or protrusions configured to engage with the interior of the housing around the edge of the vent hole.

By providing a resilient element that snaps the seal into place, but does not allow easy external removal of the seal, assembly of the unit/device can be simplified without reducing safety of the complete device.

In the first or second aspect, there is optionally a cavity within the housing adjacent to at least one possible vent point of the battery, the cavity being configured to receive the fluid released during degassing of the battery.

If the released fluid comprises a gas, the cavity allows expansion and cooling of the fluid, improving safety.

In the first or second aspect, there is optionally an absorbent material arranged within the housing to absorb the fluid released during degassing of the battery.

An absorbent material improves safety by decreasing leakage of liquids produced by a degassing event. Additionally, an absorbent material will dampen the force of a violent degassing event.

In the first or second aspect, the fluid directing arrangement optionally comprises a battery frame supporting the battery within the housing.

Combining the functions of battery support and fluid directing simplifies construction. Additionally, a battery frame may reduce the chance of degassing due to an impact on the device/unit (e.g. dropping the device/unit).

Optionally, the battery comprises a first end having a first electrical contact, a second end having a second electrical contact, the second end opposing the first end, and a side wall extending between the first end and the second end, and the battery frame is configured to support at least one of the first end and the second end, and to leave at least a part of the side wall of the battery exposed within the housing.

By supporting one or both ends of the battery, where the contacts are located, while leaving at least a part of the side wall exposed, the chance of degassing occurring near an electrical contact is reduced, such that the device/unit is more likely to be partly functional after a minor degassing event.

Optionally, the battery frame comprises a part extending across an internal volume of the housing and connected to the housing, to form a shield part between a first end of the battery and one portion of the internal volume of the housing.

Such a shield part allows the battery to be isolated from other components, meaning that the device can be more effectively repaired or recycled after a degassing event.

Optionally, the shield part is a heat shield.

Providing a heat shield further isolates the battery from other components.

Optionally, the battery frame further comprises one or more open regions extending along a side wall of the battery or a second end of the battery, the second end opposing the first end, the one or more open regions forming part of the fluid directing arrangement.

Such open regions along the battery improve fluid communication around the battery to the vent hole, increasing the chance that a degassing event can be safely relieved through the vent hole.

Optionally, the battery frame further comprises two supports arranged to extend along opposing side wall parts of the battery.

Side wall supports help to keep the battery stable within the housing, while permitting degassing over a wide remaining surface area of the battery.

Optionally, according to the first aspect, the shield part is arranged between the battery and the heating chamber.

This configuration provides mutual protection of the heating chamber from degassing events, and of the battery from heat leaking from the heating chamber.

### BRIEF DESCRIPTION OF THE DRAWINGS

FIG. 1 is a schematic cross-section of an aerosol generation device according to a first embodiment;

FIGS. 2A and 2B are schematic cross-sections of an aerosol generation device according to a second embodiment, from different viewpoints;

FIG. 2C is a schematic illustration of an aerosol generation device according to the second embodiment;

FIG. 3A is a schematic illustration of the exterior of an aerosol generation device according to the second embodiment;

FIGS. 3B and 3C are schematic illustrations of a seal for the aerosol generation device, viewing outward-facing and inward-facing sides, respectively;

FIG. 4 is a schematic illustration of a battery unit according to an embodiment.

### DETAILED DESCRIPTION

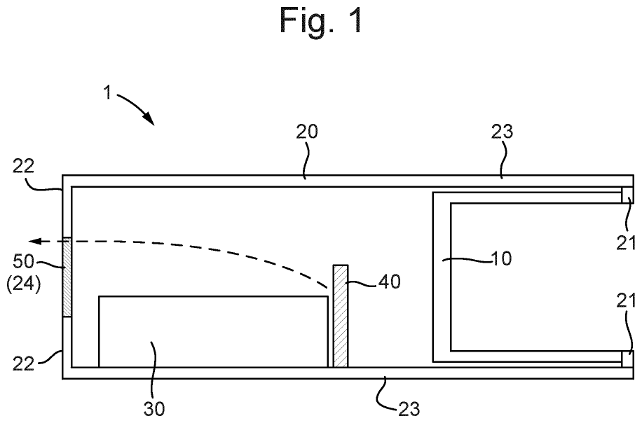

FIG. 1 is a schematic cross-section of an aerosol generation device 1 according to a first embodiment.

The aerosol generation device 1 comprises a heating chamber 10, a housing 20, a pouch-type battery 30, a fluid directing arrangement 40 and an optional seal 50.

The heating chamber 10 is operable to use power from the pouch battery 30 to heat an aerosol substrate, such as tobacco, to generate an aerosol. For example, the heating chamber 10 may comprise a ceramic or metal cylindrical wall, open at one end, and surrounded by an insulator. An open end of the heating chamber 10 is preferably oriented with a mouth end 21 of the housing. In other embodiments, the device 1 may comprise tubing to transfer a generated aerosol from the heating chamber 10 to the mouth end 21 of the housing. The heating chamber 10 receives electrical power to drive the heater. For example, the heater may be a resistive heater, such as a resistive track that is either attached to the chamber, for example as a thin film, or located inside or around the chamber wall, or may be a blade heater that protrudes into the chamber and is operable to penetrate into the aerosol substrate.

The housing 20 comprises the mouth end 21 at which generated aerosol is provided for a user to inhale. For example, the mouth end 21 may comprise an opening and a lid. The lid may, for example, be a hinged lid, detachable lid, or a sliding lid. In other embodiments, the mouth end 21 may be open to allow the aerosol to leave the device 1.

The housing 20 further comprises an opposing end 22 opposing the mouth end 21. As shown in FIG. 1, side walls 23 of the housing 20 may be relatively long and narrow between the mouth end 21 and the opposing end 22. With this shape, a user can easily hold the device 1 on the long and narrow sides 23, in order to place an aerosol substrate in the heating chamber 10 via the mouth end 21 or to bring the mouth end 21 to the user's mouth to inhale the aerosol generated in the heating chamber 10 via the mouth end 21.

The opposing end 22 comprises a vent hole 24 through which fluid released during degassing may escape from the aerosol generation device 1. The vent hole 24 is preferably maximised in size to allow the fluid to escape with as small a build-up of pressure, temperature or fluid as possible.

In preferred embodiments, the housing 20 comprises a metal, such as aluminium, for robustness. An exterior surface of the housing 20 may be partially or completely covered with a thermal insulator, such as a polymer grip, such that the device 1 can be held by a user even if heat from the heating chamber 10 partly dissipates in the housing 20.

In a pouch battery 30, there are multiple possible vent points. For example, the internal structure of the battery 30 may be unknown or random, such that a significant portion of the surface of the battery constitutes a continuum of possible vent points. As shown in FIG. 1, the pouch battery 30 may be arranged partially in contact with other components, such as an inner surface of the housing 20.

Where the surface of the pouch battery 30 is against the housing 20, this can have the effect of increasing the force required to breach the battery 30 and thus making venting less likely where the surface of the pouch battery 30 is against the housing. In this case, the number of possible vent points may be reduced, such that venting is more likely in the unsupported parts of the surface of the battery 30. At each remaining vent point (e.g. in an unsupported part of the surface) fluid may be released within the housing 20.

In the first embodiment, the fluid directing arrangement 40 is a simple protrusion within the housing 20, from an internal surface of the housing 20. The fluid directing arrangement 40 is arranged as a barrier such that fluid released during degassing of the battery 30 is directed towards the vent hole 24 in the opposing end 22 of the housing 20, approximately following the dashed arrow illustrated in FIG. 1, regardless of which of the possible vent points of the pouch battery release the fluid. By directing degassing towards the vent hole 24 in the opposing end 22, the heat and/or force associated with degassing is less likely to affect the user of the device, whose hand may be around the side walls 23, and whose face may be near the mouth end 21. The fluid directing arrangement 40 may also include a part of the internal surface of the housing 20, such as the side wall 23 where its inner surface faces the battery 30.

The fluid directing arrangement 40 may partially or completely divide an internal volume of the housing 20 to isolate the battery 30 from other components such as the heating chamber 10. This may be achieved by arranging the fluid directing arrangement to extend across an internal volume of the housing 20 and connect to the housing, to form a shield between the battery 30 and a portion of the internal volume of the housing 20. By isolating the battery 30 from other components, the other components are less likely to be damaged during a degassing event, and it is more likely that the device 1 can be repaired or recycled following a degassing event.

As shown in FIG. 1, a fluid flow path from the possible vent points of the battery 30 to the vent hole 24 may comprise a cavity within the housing 20. The cavity provides a space configured to receive the fluid released during degassing. In small degassing events, the internal volume of the cavity may be large enough to dissipate the force and/or heat of the degassing event.

Part of the cavity may be filled with an absorbent material arranged to absorb the fluid released during degassing. Alternatively, the cavity may be entirely replaced with an absorbent material arranged within the housing. The absorbent material will at least partly absorb and/or slow down fluid flowing along the fluid flow path as a result of a degassing event, thereby reducing the force, heat and/or chemical risk associated with fluid vented from the battery 30 and out through the vent hole 24. The absorbent material may, for example, comprise a porous material such as a metal (e.g. aluminium) or plastic, in the form of a mesh, wool or sponge.

In the first embodiment, the vent hole 24 is initially blocked by a seal 50 positioned across the vent hole. The seal 50 is configured to be displaced (e.g. pushed out of the vent hole 24) or broken (e.g. cracked, shattered or melted) during degassing of the battery, such that pressure associated with degassing can be relieved in a degassing event, without leaving the vent hole 24 open during normal operation of the device 1. In other words, prior to being displaced or broken, the seal 50 is effectively a portion of the housing 20. The seal 50 comprises a material that is weaker than a material of the housing 20, and/or has a lower melting point, such that the material of the seal 50 is broken or displaced before any damage to the housing 20 occurs. The seal 50 may take the form of a plug comprising a plastic material, such as a plastic resin, or may take the form of a cover comprising a plastic or foil, such as a PET-foil sticker. Alternatively, the seal 50 may be omitted, and the vent hole 24 left open.

The device 1 may additionally comprise control circuitry (not shown) is configured to control the supply of electrical power from the heating chamber. The control circuitry may be as simple as a manual switch that can be operated by the user. However, the control circuitry is preferably complex enough to regulate the power supply to provide a required heating rate in the heating chamber, for example using a buffer, a booster and/or an amplifier. The control circuitry may also perform other functions such as sensing a charge state of the pouch battery 30, recharging the pouch battery 30, providing automatic control of the heating chamber 10 to provide a predetermined amount or strength of aerosol according to user inputs, and controlling output elements (such as LEDs) to indicate a status of the device. Each of the heating chamber 10 and the pouch battery 30 may be directly connected to the control circuitry or may be connected via wires and/or rigid tabs. Tab connections may comprise, for example, steel, nickel or nickel-plated steel.

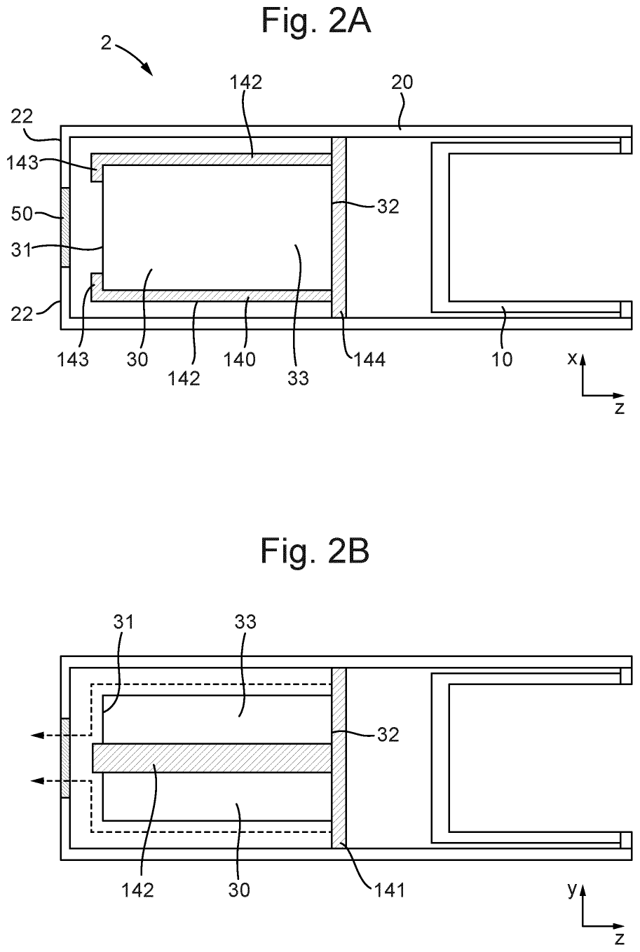

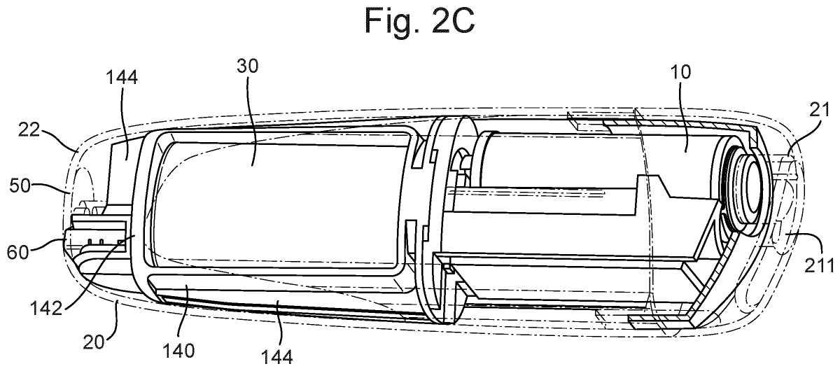

A second embodiment of an aerosol generation device 2 is illustrated in FIGS. 2A to 2C. FIGS. 2A and 2B are schematic cross-sections of the aerosol generation device according to a second embodiment, from different rotated viewpoints (as indicated by the Cartesian axes x, y, z). FIG. 2C is a CAD model example of the aerosol generation device of the second embodiment.

The second embodiment is largely similar to the above-described first embodiment, but the fluid directing arrangement now comprises a battery frame 140 supporting the battery 30 within the housing.

Referring to FIGS. 2A and 2B, in this embodiment, the pouch battery 30 comprises two ends 31, 32 each having an electrical contact for supplying power from the battery 30, and comprises a side wall extending between the first end and the second end. The battery frame 140 is configured to support at least one of the ends 31, 32 of the battery 30 while leaving at least part of the side wall 33 open and exposed within the inner volume of the housing 20. The part of the side wall 33 which is left exposed forms an area of possible vent points, allowing fluid to escape from the battery 30 while it is held in place by the battery frame 140 within the housing 20 (for example along the path of the dashed arrows in FIG. 2B). The corresponding open regions of the battery frame 140, through which the battery 30 is exposed, form part of the fluid directing arrangement to guide fluid released during degassing towards the vent hole 24. The battery frame material may be chosen to be less rigid than that of the housing 20, such that exterior impacts (such as dropping the device) transfer less energy to the battery 30 and have less chance of triggering a degassing event.

A shield part 141 of the battery frame 140 may be provided extending across the internal volume of the housing 20 and connected to the housing, between a first end 32 of the battery and a portion of the internal volume of the housing 20. In this case, the shield part 141 separates a part of the internal volume in which the heating chamber 10 is disposed, from a part of the internal volume in which the battery 30 is disposed. The battery frame 140 thus serves the dual functions of protecting the battery 30 from causes of degassing (such as external impacts) and protecting other components from the effects of degassing.

The battery frame 40 may for example, be manufactured from a heat resistant material such as PEEK (polyether ether ketone), in which case the shield part 141 is not only a physical barrier for fluid released during degassing but also a heat shield for heat released during degassing.

The battery frame 140 may take a variety of forms. In FIGS. 2A and 2B, the battery frame comprises a side part 142 taking the form of two supports arranged to extend along opposing side wall parts of the battery 30. More generally, the battery frame 140 can in embodiments comprise a plurality of supports around the side wall 33 of the battery 30, with one or more open regions extending along the side wall 33. The side part 142 may act as a second heat shield wall when the battery frame 40 comprises heat resistant material.

Additionally, the battery frame comprises an end part 143 to support a second end 31 of the battery 30. In the second embodiment, the end part 143 is partly open such that degassing can occur from the second end 31. Alternatively, the end part 143 could cover the whole of the second end 31. The end part 143 could be removed in cases where friction between the side part 142 and the battery 30 is sufficient to hold the battery 30 in place.

Turning to FIG. 2C, a specific example of the second embodiment is illustrated in the form of a CAD model. The described features of the specific example are generally independent and may be individually added to the second embodiment.

In FIG. 2C, the housing 20 is rendered transparent for illustrative purposes, and may be actually transparent in some embodiments. For example, the housing may be partly a metal frame and partly a transparent plastic. In a preferred embodiment, however, the housing 20 is a solid metal (such as aluminium) for robustness.

As shown in FIG. 2C, the battery frame 140 may additionally comprise one or more protrusions or fins 144 which extend to an inner surface of the housing 20. These protrusions or fins increase the area of contact between the battery frame 140 and the housing 20 and increase the stability of the battery frame 140 within the housing.

Furthermore, as shown in FIG. 2C, the opposing end 22 of the housing may in some embodiments comprise a charging port 60 arranged alongside the vent hole 24 and seal 50, for charging the pouch battery 30. The charging port 60 may be a generic port, such as a USB socket, or may be a proprietary port that ensures the device is only connected to an appropriate electric charging source.

Furthermore, as shown in FIG. 2C, the mouth end 21 may comprise an opening which is covered by a slider 211 in a default state, and which may be opened to expose the heating chamber 10 when the device is to be used for generating an aerosol.

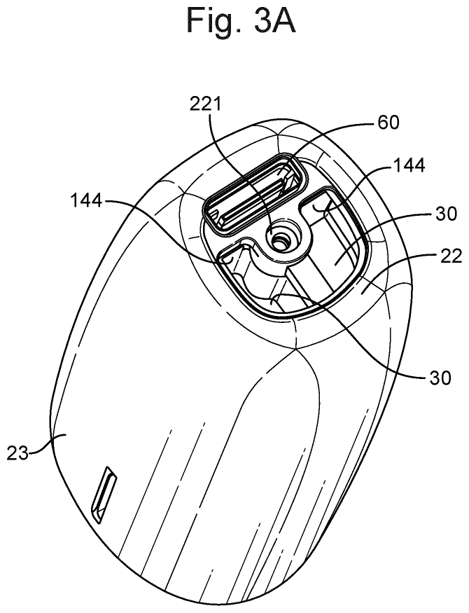

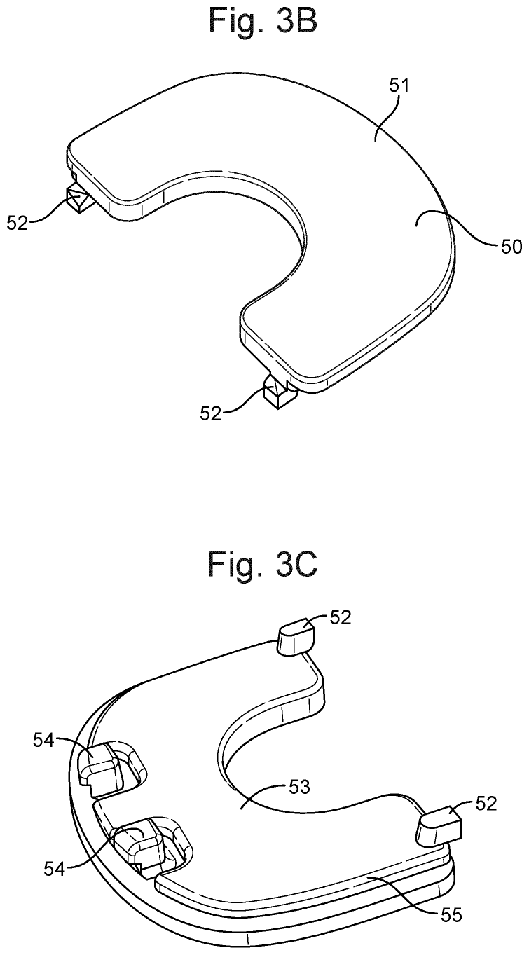

FIG. 3A is a schematic illustration of the exterior of the aerosol generation device 2 according to the second embodiment. FIGS. 3B and 3C are schematic illustrations of the seal 50 for the aerosol generation device, viewing outward-facing 51 and inward-facing 53 sides, respectively.

As further illustrated in FIG. 3A, the opposing end 22 of the housing may comprise a fastener hole 221 for attaching the battery frame 140 to the opposing end 22 using a fastener such as a screw. This may be a reversible fastener, such that the device 2 can be disassembled.

In FIG. 3A, the vent hole 24 has a U-shape arranged around the fastener hole 221. More generally, as mentioned above, the vent hole 24 is preferably maximized in size to increase its effectiveness for releasing fluid generated in degassing away from a user of the device 2, and/or away from some components within the device.

FIG. 3A also illustrates that the end part 143 of the battery frame 140 may have substantial gaps exposing the battery 30 to face the vent hole 24. In this example, the battery is supported away from the vent hole 24 by narrow fins 144.

FIGS. 3B and 3C illustrate one embodiment of how a seal 50 may be held in place prior to a degassing event. Tabs (protrusions) 52 and 54 may engage with the interior of the housing 20 around the edge of the vent hole 24 in order to hold the seal in place.

At least one tab 52 may be resilient so that it can be snapped into place during assembly of the device 2. If the seal 50 is displaced without damage in a degassing event, a resilient tab 52 allows the seal 50 to be reused. Alternatively, it may be preferred that the seal 50 cannot be reused, in which case the tabs 52 may be designed not to bend without breaking, once they are in place in the device 2.

Alternatively, the seal 50 may be held in place by a friction fit that is strong enough to hold under normal conditions, but releases either due to a force associated with degassing, or releases when the seal 50 breaks.

The seal 50 of this embodiment has no means for a user to manually remove the seal 50 and has a smooth external surface 51, so that the seal 50 remains in place until a degassing event occurs. This may improve safety by ensuring that the vent hole remains closed and blocks out contamination (e.g. water) from the device until the vent hole is needed in a degassing event.

The seal 50 of this embodiment also comprises a stepped surface 55 which fits against a corresponding stepped surface on the housing 20 around the vent hole. This optional feature improves the sealing of the vent hole against contamination (e.g. water) by providing a significant surface area where there can only be a small gap between the housing 20 and the seal 50.

The seal 50 and vent hole 24 of FIGS. 3A to 3C may equally be applied to the first embodiment.

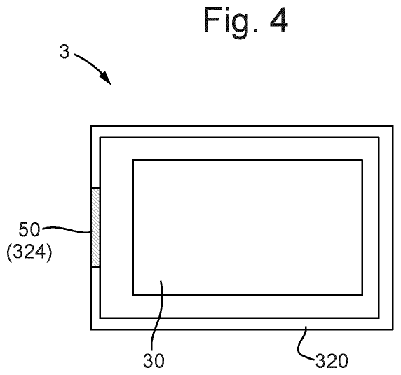

The features of the first and second embodiments may also be applied more generally for a battery unit, as shown in FIG. 4.

In the example shown in FIG. 4, a battery unit 3 comprises a pouch battery 30, similar to the pouch battery of the first or second embodiment. The pouch battery 30 is enclosed in a housing 320. The housing 320 comprises a vent hole 324 initially closed by a seal 50, similar to the first or second embodiment. By providing vent hole 324, a venting direction of the battery unit 3 becomes well-defined, as opposed to the lone pouch battery 30 having multiple possible venting points.

The housing 320 is similar to the housing 20 and fluid directing arrangement 40, 140 of the first or second embodiment, in terms of its materials and purpose. In the event of degassing, the housing 320 will define a fluid flow path from the battery 30 to the vent hole 324 for fluid to be safely released. In this case, the battery unit 3 does not have a heating chamber, but may, for example, have regulator electronics to control the power supply from the battery unit. Such electronics may be shielded from degassing events by a fluid directing arrangement or battery frame as described above.

A battery unit 3 according to the invention may furthermore comprise a plurality of pouch batteries 30 encased in a single housing 320.

Such a battery unit 3 may be specifically adapted for an aerosol generation device, externally comprising electrical contacts and engagement means for electrical and mechanical connection in the aerosol generation device. Alternatively, the battery unit 3 may be a general purpose battery unit having external electrical contacts for supplying power from the one or more pouch batteries 30 therein.

1-22. (canceled)

23. A battery unit for an aerosol generation device comprising:
a housing comprising a vent hole;
a pouch battery within the housing, an outer surface of the battery comprising a plurality of possible vent points where a fluid may be released during degassing of the battery; and
a fluid directing arrangement within the housing, the fluid directing arrangement being configured to define a fluid flow path from each of the plurality of possible vent points of the battery to the vent hole of the housing.

24. The battery unit according to claim 23, further comprising a seal positioned across the vent hole of the housing, the seal being configured to be displaced or broken to open the vent hole during degassing of the battery.

25. The battery unit according to claim 23, wherein the fluid directing arrangement comprises a first heat shield wall which is positioned closer to a first end of the battery and the vent hole of the housing is positioned closer to a second end of the battery which is opposite to the first end.

26. The battery unit according to claim 25, wherein the fluid directing arrangement further comprises a second heat shield wall which is positioned adjacent a side of the battery.

27. The battery unit according to claim 26, wherein the fluid directing arrangement further comprises an opening which is positioned adjacent a side of the battery for leaving the battery exposed; the opening extending along the second heat shield wall.

28. The battery unit according to claim 26, wherein the second heat shield wall is separated from the housing such as to leave a cavity therebetween.

29. The battery unit according to claim 24, wherein the housing comprises a first material and the seal is a housing portion comprising a second material, the second material being weaker than the first material.

30. The battery unit according to claim 24, wherein the housing comprises a first material and the seal is a housing portion comprising a second material, the second material having a lower melting point than the first material.

31. The battery unit according to claim 30, wherein the first material is a metal and the second material is a plastic.

32. The battery unit according to claim 29, wherein the seal is a plug comprising a plastic material or a cover comprising a plastic or foil.

33. The battery unit according to claim 30, wherein the seal comprises a resilient element configured to engage with the housing to snap the seal into place during assembly, but configured to inhibit external removal of the seal from the housing.

34. The battery unit according to claim 33, wherein the resilient element is a tab or a protrusion configured to engage with an interior of the housing around an edge of the vent hole.

35. The battery unit according to claim 23, comprising a cavity within the housing adjacent to at least one of the plurality of possible vent points of the battery, the cavity being configured to receive fluid released during degassing of the battery.

36. The battery unit according to claim 23, comprising an absorbent material arranged within the housing to absorb fluid released during degassing of the battery.

37. The battery unit according to claim 23, wherein the fluid directing arrangement comprises a battery frame supporting the battery within the housing.

38. The battery unit according to claim 37, wherein:
the battery comprises a first end having a first electrical contact, a second end having a second electrical contact, the second end opposing the first end, and a side wall extending between the first end and the second end, and
the battery frame is configured to support at least one of the first end and the second end, and to leave at least a part of the side wall of the battery exposed within the housing.

39. The battery unit according to claim 37, wherein the battery frame comprises a part extending across an internal volume of the housing and connected to the housing, to form a shield part between a first end of the battery and one portion of the internal volume of the housing.

40. The battery unit according to claim 39, wherein the shield part is a heat shield.

41. The battery unit according to claim 39, wherein the battery frame further comprises one or more open regions extending along a side wall of the battery or a second end of the battery, the second end opposing the first end, the one or more open regions forming part of the fluid directing arrangement.

42. The battery unit according to claim 41, wherein the battery frame further comprises two supports arranged to extend along opposing side wall parts of the battery.

43. An aerosol generation device comprising:
a heating chamber operable to heat an aerosol substrate to generate an aerosol; and
the battery unit according to claim 23, wherein the housing further comprises a mouth end and an opposing end, the vent hole disposed at the opposing end.

44. The aerosol generation device according to claim 43, further comprising a seal positioned across the vent hole, the seal being configured to be displaced or broken to open the vent hole during degassing of the battery.

45. The aerosol generation device according to claim 43, wherein the fluid directing arrangement comprises a battery frame supporting the battery within the housing, wherein the battery frame comprises a part extending across an internal volume of the housing and connected to the housing, to form a shield part between a first end of the battery and one portion of the internal volume of the housing, and wherein the shield part is arranged between the battery and the heating chamber.
